(19) United States
(12) Patent Application Publication
(10) Pub. No.: US 2021/0073604 A1
(43) Pub. Date: Mar. 11, 2021

(54) IMAGE FORMING APPARATUS AND TONER CARTRIDGE

(71) Applicant: TOSHIBA TEC KABUSHIKI KAISHA, Tokyo (JP)

(72) Inventor: Shiho Moriya, Mishima Shizuoka (JP)

(21) Appl. No.: 16/565,551

(22) Filed: Sep. 10, 2019

(51) Int. Cl. G06K 15/00; G03G 15/08

(52) U.S. Cl. CPC G06K 15/4075; G03G 15/0856

(57) ABSTRACT

According to one embodiment, there is provided an image forming apparatus including a derivation unit that derives remaining amount information on a remaining amount of a recording agent in a recording agent cartridge based on a physical quantity acquired by an operation acquisition unit, characteristic information acquired by a characteristic acquisition unit, and a recording agent amount acquired by a recording agent amount acquisition unit.

### FIELD

Embodiments described herein relate generally to an image forming apparatus, a toner cartridge, and methods related thereto.

### BACKGROUND

There is an image forming apparatus that replenishes toner from an attached toner cartridge. The image forming apparatus detects the remaining amount of toner in the attached toner cartridge. As a method of detecting the remaining amount, there is a method based on the number of rotations and the driving time of a motor for replenishing toner. In this method, the remaining amount is detected on the assumption that toner is replenished in proportion to the number of rotations of the motor and the like.

However, since there are various characteristics for each toner, there is a problem that an error may occur in the remaining amount which is simply assumed to be replenished in proportion to the number of rotations of the motor and the like.

### DESCRIPTION OF THE DRAWINGS

FIG. 1 is an external view illustrating an example of the overall configuration of an image forming apparatus according to an embodiment;

FIG. 2 is a block diagram illustrating a configuration related to detection of a remaining amount of toner;

FIG. 3 is a diagram illustrating the configuration of a control system of the image forming apparatus;

FIG. 4 is a diagram illustrating a data structure of toner characteristic information;

FIG. 5 is a diagram illustrating a data structure of toner characteristic information;

FIG. 6 is a diagram illustrating details of threshold value information;

FIG. 7 is a diagram illustrating definitions of Levels;

FIG. 8 is a diagram illustrating a relationship between a bulk density difference and an amount of replenishment;

FIG. 9 is a diagram illustrating an integration update correction factor;

FIG. 10 is a diagram illustrating a replenishment counter correction factor;

FIG. 11 is a diagram illustrating a relationship between flow characteristics and an amount of replenishment;

FIG. 12 is a diagram illustrating an integration update correction factor;

FIG. 13 is a diagram illustrating a replenishment counter correction factor;

FIG. 14 is a diagram illustrating a relationship between an amount of fine powder and an amount of replenishment, and a relationship between an average particle diameter and an amount of replenishment;

FIG. 15 is a diagram illustrating an integration update correction factor;

FIG. 16 is a diagram illustrating a replenishment counter correction factor;

FIG. 17 is a flowchart illustrating a flow of a remaining amount information derivation process performed by a control unit when an integration update correction factor is used;

FIG. 18 is a flowchart illustrating a flow of a remaining amount display process; and

FIG. 19 is a flowchart illustrating a flow of a remaining amount information derivation process performed by the control unit when a replenishment counter correction factor is used.

### DETAILED DESCRIPTION

In general, according to one embodiment, an image forming apparatus includes a replenishing unit, an operation acquisition unit, a characteristic acquisition unit, a recording agent amount acquisition unit, and a derivation unit. The replenishing unit replenishes a recording agent from a recording agent cartridge to a collecting unit. The operation acquisition unit acquires a physical quantity that is proportional to operation of the replenishing unit. The characteristic acquisition unit acquires characteristic information determined by characteristics of the recording agent. The recording agent amount acquisition unit acquires a recording agent amount indicating an amount of the recording agent collected in the collecting unit. The derivation unit derives remaining amount information on a remaining amount of the recording agent in the recording agent cartridge based on the physical quantity acquired by the operation acquisition unit, the characteristic information acquired by the characteristic acquisition unit, and the recording agent amount acquired by the recording agent amount acquisition unit.

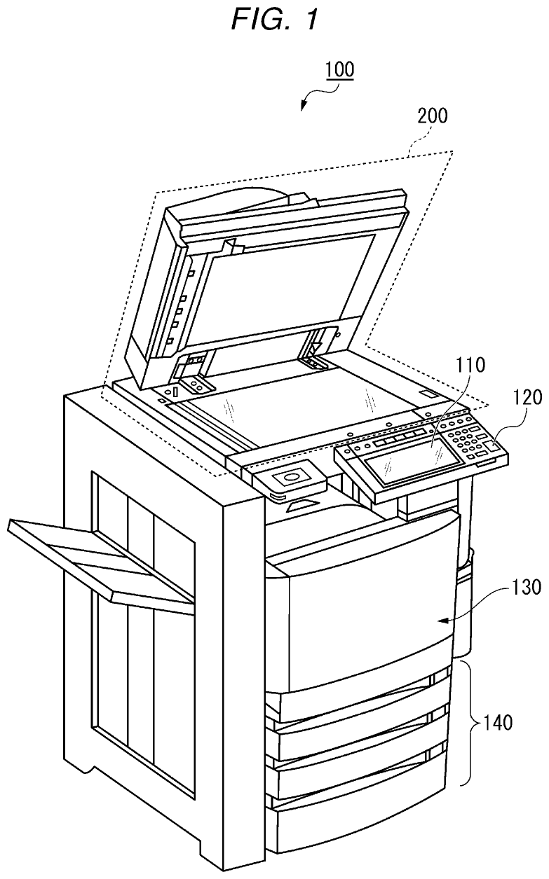

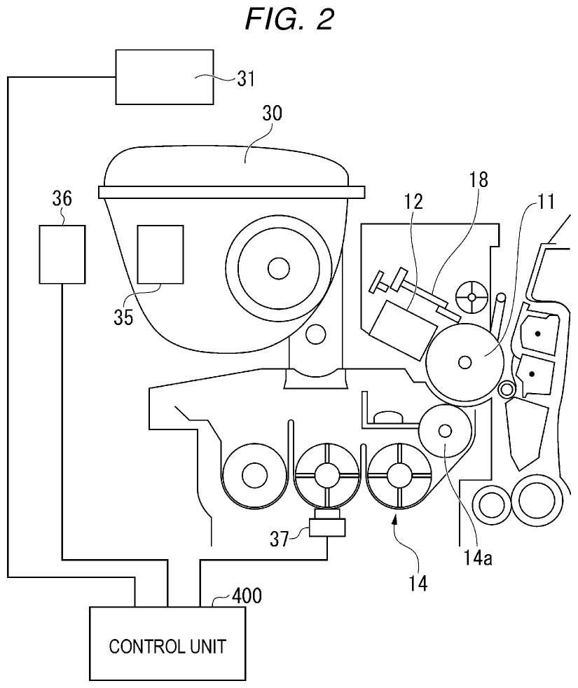

FIG. 1 is an external view illustrating an example of the overall configuration of an image forming apparatus 100 according to an embodiment. The image forming apparatus 100 is, for example, a multifunction peripheral. The image forming apparatus 100 includes a display 110, a control panel 120, a printing unit 130, a sheet storage unit 140, and a scanning unit 200. The image forming apparatus 100 includes a control unit 400 that controls the entire apparatus illustrated in FIG. 2. The image forming apparatus 100 forms an image on a sheet using a developer. A developer is, for example, toner. In the following description, the developer is described as toner. A sheet is, for example, paper or label paper. The sheet may be any material as long as the image forming apparatus 100 can form an image on its surface.

The display 110 is an image display device such as a liquid crystal display or an organic electro luminescence (EL) display. The display 110 displays various types of information related to the image forming apparatus 100.

The control panel 120 includes a plurality of buttons. The control panel 120 receives an operation of a user. The control panel 120 outputs a signal corresponding to the operation performed by the user to the control unit 400 of the image forming apparatus 100. The display 110 and the control panel 120 may be configured as an integrated touch panel.

The printing unit 130 prints an image on a sheet based on image information generated by the scanning unit 200 or image information received via a network. The printing unit 130 prints an image using toner. The sheet on which the image is printed may be a sheet stored in the sheet storage unit 140 or a pointed sheet.

The sheet storage unit 140 stores a sheet used for image formation in the printing unit 130.

The scanning unit 200 reads image information to be read as brightness and darkness of light. The scanning unit 200 records the read image information. The recorded image information may be transmitted to another information processing apparatus via a network. The recorded image information may be used to form an image on the sheet by the printing unit 130.

FIG. 2 is a block diagram illustrating a configuration related to detection of a remaining amount of toner in the image forming apparatus 100.

In FIG. 2, the control unit 400, a toner cartridge 30, a toner replenishment motor 31, a storage medium 35, a read and write unit 36, and a toner remaining amount detection sensor 37 are illustrated. A photosensitive drum 11, a charger 12, a developing device 14, a developing drum 14a, and a cleaner 18 are illustrated in FIG. 2.

The photosensitive drum 11 includes an organic photo conductor (OPC) on the surface of a support member. The charger 12 uniformly charges the photosensitive drum 11 sequentially as the photosensitive drum 11 rotates. The cleaner 18 removes residual toner on the photosensitive drum 11. The developing device 14 develops an electrostatic latent image formed on the photosensitive drum 11 with toner by the developing drum 14a.

As illustrated in the upper part of FIG. 2, the toner cartridge 30 is provided in the upper portion of the developing device 14. By rotation of the toner replenishment motor 31, a replenishment mechanism (supply auger) in the toner cartridge 30 is driven to drop and supply the toner into the developing device 14. The toner replenishment motor 31 is an example of the replenishing unit. The developing device 14 is an example of the collecting unit.

The developing device 14 is provided with the toner remaining amount detection sensor 37 that measures a magnetic permeability of the developer. The toner remaining amount detection sensor 37 acquires a toner amount indicating the amount of toner stored in the developing device 14. As the toner amount, a mass ratio (T/C) of the toner to a carrier is used. It is possible to detect that the toner is insufficient by the measurement value of the toner remaining amount detection sensor 37. The toner remaining amount detection sensor 37 is an example of the recording agent amount acquisition unit.

The toner cartridge 30 includes the storage medium 35. The storage medium 35 stores toner characteristic information on the toner cartridge 30. The read and write unit 36 executes reading of information and writing of information to the storage medium 35. The toner characteristic information may be stored in the storage medium 35 or may be stored in the image forming apparatus 100. In order to distinguish the information, information stored in the storage medium 35 is referred to as toner characteristic information A, and information stored in the image forming apparatus 100 is referred to as toner characteristic information B. When the toner characteristic information A and the toner characteristic information B are not distinguished from each other, the toner characteristic information A and the toner characteristic information B are expressed as toner characteristic information. In the image forming apparatus 100, when the toner cartridge 30 is set in the image forming apparatus 100 and the cover for storing the toner cartridge 30 is closed, the toner characteristic information A can be acquired from the toner cartridge 30. The acquired toner characteristic information A is stored in the image forming apparatus 100 as the toner characteristic information B.

The toner replenishment motor 31, the read and write unit 36, and the toner remaining amount detecting sensor 37 described above are controlled by the control unit 400.

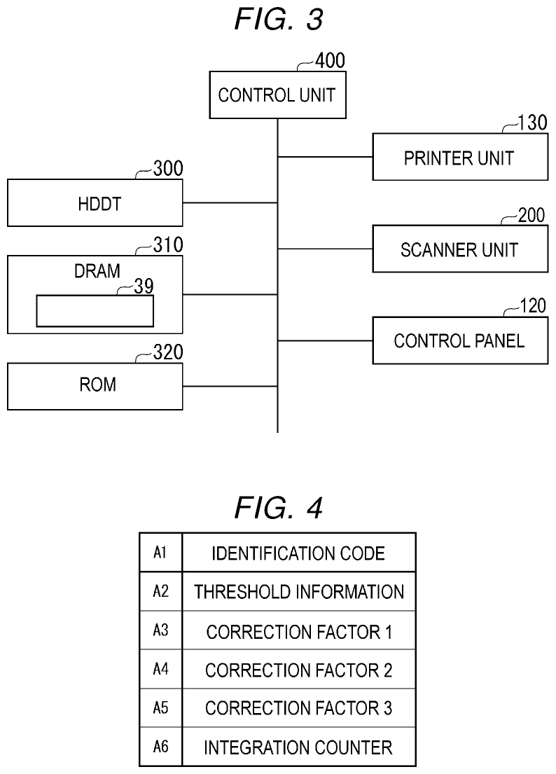

FIG. 3 is a diagram illustrating the configuration of a control system of the image forming apparatus 100.

The image forming apparatus 100 includes the printing unit 130, the scanning unit 200, the control panel 120, the control unit 400, a hard disk drive (HDD) 300, a dynamic random access memory (DRAM) 310, and a read only memory (ROM) 320. These units are connected via a system bus.

The ROM 320 stores various control programs required to operate the image forming apparatus 100. The ROM 320 stores a program for controlling an image forming operation and a toner remaining amount management operation. The execution of each program is controlled by the control unit 400. The DRAM 310 is a buffer memory that temporarily stores data generated when each program is executed. An area 39 of the DRAM 310 is an area where the toner characteristic information B is stored.

The control unit 400 is directly or indirectly connected to at least the toner remaining amount detecting sensor 37, a temperature and humidity sensor 38, the read and write unit 36, and the toner replenishment motor 31 illustrated in FIG. 2. The control unit 400 controls the operation of each unit connected via a system bus and each unit related to toner remaining amount management.

Next, a remaining amount information derivation process for deriving the remaining amount information on the remaining amount of toner in the toner cartridge 30 will be described. In the remaining amount information derivation process, a toner amount indicating the amount of toner stored in the developing device 14 is acquired. In the remaining amount information derivation process, the toner characteristic information is acquired. In the remaining amount information derivation process, the physical quantity in proportion to the operation of the toner replenishment motor 31 is acquired. In the embodiment, a counter is used as the physical quantity in proportion to the operation of the toner replenishment motor 31. The counter is an amount determined from the operating time of the toner replenishment motor 31, and is directly proportional to the operating time.

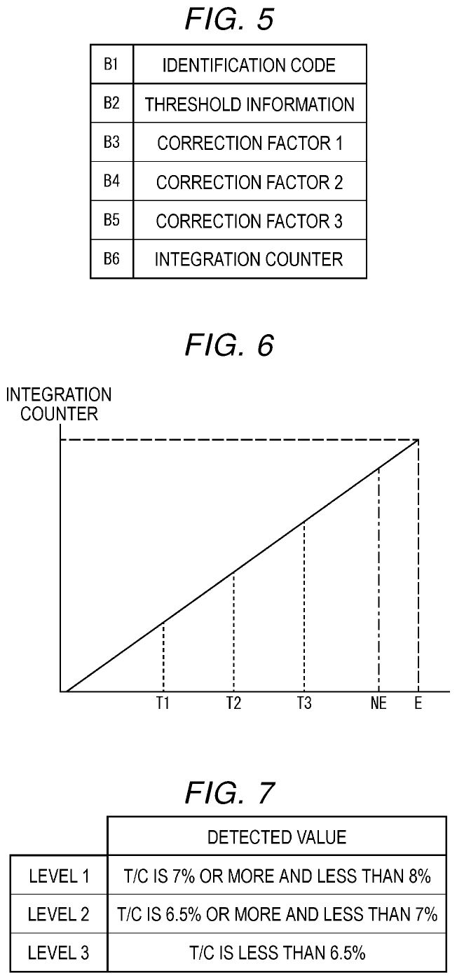

First, the details of the toner characteristic information described above will be described. FIG. 4 is a diagram illustrating the data structure of the toner characteristic information A. FIG. 5 is a diagram illustrating the data structure of the toner characteristic information B. As illustrated in FIGS. 4 and 5, the toner characteristic information A and the toner characteristic information B have the same data structure. A1 to A6 illustrated in FIG. 4 and B1 to B6 illustrated in FIG. 5 indicate leading addresses at which respective data are stored.

The toner characteristic information includes an identification code, threshold information, correction coefficients 1 to 3, and a counter. The identification code is information for identifying the toner cartridge 30. The threshold information is information indicating a threshold that is an indicator of the remaining amount. The correction coefficients 1 to 3 are coefficients determined according to the characteristics of toner. The correction coefficients 1 to 3 are coefficients to be calculated with the counter. The integration counter is an integrated value of the counter. Thus, the toner characteristic information is information determined by the characteristics of toner. The toner characteristic information is information for deriving the remaining amount information on the remaining amount of toner in the toner cartridge 30.

FIG. 6 is a diagram illustrating the detail of threshold value information. The threshold information is constituted by T1 to T3, NE, and E. T1 to T3, NE, and E are values to be compared with the integration counter. As the integration counter increases, more toner is replenished by the toner replenishment motor 31. The integration counter is an example of remaining amount information.

The remaining amount of toner is indicated in four stages by three thresholds: threshold T1, threshold T2, and threshold T3. The remaining amount is small in the order of the threshold T1, the threshold T2, and the threshold T3. The threshold value NE indicates that the toner will be used up soon. The threshold E indicates that toner is used up.

FIG. 7 is a diagram illustrating the definition of Levels 1 to 3 corresponding to the correction coefficients 1 to 3. Levels 1 to 3 are based on values detected by the toner remaining amount detection sensor 37. Level 1 illustrated in FIG. 7 indicates that T/C is 7% or more and less than 8%. Level 2 indicates that T/C is 6.5% or more and less than 7%. Level 3 indicates that T/C is less than 6.5%. In the normal operation, T/C does not exceed 8%. The value of T/C illustrated in FIG. 7 is appropriately determined depending on the model of an image forming apparatus or the like. Therefore, the value of T/C illustrated in FIG. 7 may be the upper side or the lower side depending on the model.

The lower the level, the smaller the amount of toner to be replenished or the amount of toner required for replenishment. Therefore, it is considered that the lower the level, the longer the time passed from toner replenishment. The toner in the toner cartridge 30 is stirred at the time of replenishment. When the time passed since the toner replenishment is long, the toner is not stirred for a while, and thus the toner is highly likely to be agglomerated. When replenishment is performed in a state where the toner is agglomerated, the agglomerated toner is replenished as it is, resulting in an increase in amount of replenishment. Therefore, when the toner replenishment motor 31 operates for the same time, as the level becomes lower, more toner is replenished.

The correction coefficient described above will be described. The correction coefficient is determined according to the characteristics of toner. The bulk density, flow characteristics, and particle diameter will be described as examples of toner characteristics.

First, an embodiment using bulk density to illustrate the characteristics of toner will be described. The bulk density includes loose bulk density and packed bulk density. The loose bulk density is a bulk density when a powder is loosely packed without being compacted. The packed bulk density is a bulk density when a powder is densely packed.

The following measurement methods are mentioned as a method of measuring bulk density. A measurer puts 10 g of toner in a 50 ml measuring cylinder, reads the memory (ml) immediately after stirring by closing the cylinder with a lid and shaking up and down 50 times and calculates the loose bulk density (g/ml). The measurer reads the memory (ml) after leaving the measuring cylinder after stirring for 10 minutes, and calculates the packed bulk density (g/ml).

When a difference between the packed bulk density and the loose bulk density is large, the flow characteristics are generally deteriorated. The difference between the loose bulk density and the packed bulk density is expressed as a bulk density difference. When the bulk density difference is large, the flow characteristics may be deteriorated and the toner may be easily thickened in the toner cartridge 30. Therefore, since the toner is more likely to be replenished in an agglomerated state, the amount of replenishment is considered to be large.

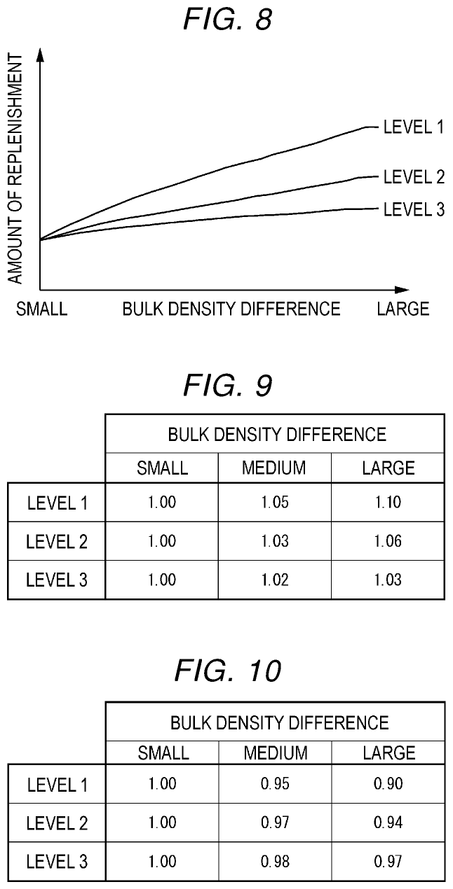

FIG. 8 is a diagram illustrating the relationship between the bulk density difference and the amount of replenishment. The vertical axis indicates the amount of replenishment, and the horizontal axis indicates the bulk density. The amount of replenishment indicates the amount of replenishment when the toner replenishment motor 31 rotates once. Levels 1 to 3 are the levels described in FIG. 7.

As described above, as the level becomes lower, more toner is replenished. As the bulk density difference increases, more toner is replenished.

Therefore, even when the counters are the same, the actual amount of replenishment varies depending on the bulk density difference and the level, and thus an error occurs in the remaining amount of the toner cartridge 30.

Therefore, in the embodiment, the occurrence of an error is prevented using the correction coefficients illustrated in FIGS. 9 and 10. The correction coefficient illustrated in FIG. 9 is a correction coefficient used when the integration counter of the toner characteristic information B is updated. The correction factor illustrated in FIG. 10 is a correction factor used when controlling the counter in toner replenishment. In order to distinguish the two correction factors, the correction factor illustrated in FIG. 9 may be expressed as integration update correction factor. The correction factor illustrated in FIG. 10 may be expressed as a replenishment counter correction factor.

In FIGS. 9 and 10, when the bulk density difference is “small”, the case indicates that a difference between the loose bulk density and the packed bulk density is less than 0.5. When the bulk density difference is “medium”, the case indicates that a difference between the loose bulk density and the packed bulk density is 0.5 or more and less than 1.0. When the bulk density difference is “large”, the case indicates that a difference between the loose bulk density and the packed bulk density is 1.0 or more.

The integration update correction factor illustrated in FIG. 9 will be described. After the toner replenishment by the toner replenishment motor 31, the control unit 400 acquires a counter for a current replenishment. The control unit 400 sets a product of the acquired counter and the integration update correction factor as a counter after correction, and adds the counter after correction to the integration counter of the toner characteristic information B.

Therefore, the correction coefficient illustrated in FIG. 9 becomes larger as the level becomes lower, and becomes larger as the bulk density difference becomes larger. At Level 1, the correction factor when the bulk density is “small” is 1.00. At Level 1, the correction factor when the bulk density is “medium” is 1.05. At Level 1, the correction factor when the bulk density is “large” is 1.10.

At Level 2, the correction factor when the bulk density is “small” is 1.00. At Level 2, the correction factor when the bulk density is “medium” is 1.03. At Level 2, the correction factor when the bulk density is “large” is 1.06.

At Level 3, the correction factor when the bulk density is “small” is 1.00. At Level 3, the correction factor when the bulk density is “medium” is 1.02. At Level 3, the correction factor when the bulk density is “large” is 1.03.

As described above, when a large amount of toner is actually replenished, the occurrence of an error can be prevented by correcting the counter to be large.

The replenishment counter correction factor illustrated in FIG. 10 will be described. When the toner replenishment motor 31 replenishes toner, the control unit 400 obtains an amount of replenishment from the amount of toner detected by the toner remaining amount detection sensor 37.

The control unit 400 acquires a counter of the toner replenishment motor 31 required to replenish toner in the amount of replenishment. The amount of replenishment and the value of the counter corresponding to the amount of replenishment are stored in advance in the ROM 320 based on Level 1 when the bulk density difference is “small”.

The control unit 400 operates the toner replenishment motor 31 for a counter after correction using a product of the acquired counter and the replenishment counter correction factor as the counter after correction.

Therefore, the correction coefficient illustrated in FIG. 10 becomes smaller as the level becomes lower and becomes smaller as the bulk density difference becomes larger. At Level 1, the correction factor when the bulk density is “small” is 1.00. At Level 1, the correction factor when the bulk density is “medium” is 0.95. At Level 1, the correction factor when the bulk density is “large” is 0.90.

At Level 2, the correction factor when the bulk density is “small” is 1.00. At Level 2, the correction factor when the bulk density is “medium” is 0.97. At Level 2, the correction factor when the bulk density is “large” is 0.94.

At Level 3, the correction factor when the bulk density is “small” is 1.00. At Level 3, the correction factor when the bulk density is “medium” is 0.98. At Level 3, the correction factor when the bulk density is “large” is 0.97.

As described above, when a large amount of toner is actually supplied, the occurrence of an error can be prevented by correcting the counter to be small.

The bulk density differences illustrated in FIGS. 9 and 10 are determined for each toner stored in the toner cartridge 30, and does not change. Therefore, any one correction coefficient of the bulk density difference is set for the correction coefficients 1 to 3 of the toner characteristic information. For example, for the integration update correction factor, the correction factor 1 when the bulk density difference of toner is “large” is 1.10. The correction factor 2 when the bulk density difference is “large” is 1.06. The correction coefficient 3 when the bulk density difference is “large” is 1.03.

Next, an embodiment using flow characteristics to illustrate the characteristics of toner will be described. When the flow characteristics are poor, the amount of replenishment is considered to be small because the toner hardly flows.

The following measurement method can be used as a method of measuring toner flow characteristics. As a measuring device used for measurement, for example, Powder Tester PT-X (manufactured by Hosokawa Micron Corporation) can be used. A measurer sets sieves of 60 mesh, 100 mesh and 200 mesh in the narrow order of mesh size on a vibration table. Thus, a 60 mesh sieve is set on the top. The measurer sets the amplitude to 0.8 mm and vibrates 20 g of toner for 30 seconds. The measurer measures the amount of toner remaining on each sieve and determines the total amount of toner remaining on the three sieves. The measurer sets the obtained total amount as flow characteristics.

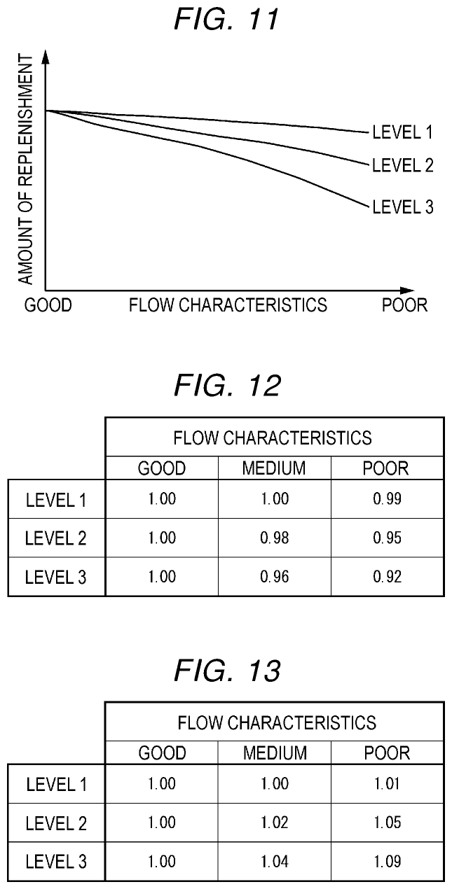

FIG. 11 illustrates the relationship between flow characteristics and the amount of replenishment. The vertical axis indicates the amount of replenishment, and the horizontal axis indicates flow characteristics. The amount of replenishment indicates the amount of replenishment when the toner replenishment motor 31 rotates once. Levels 1 to 3 are levels described in FIG. 7.

As described above, as the level becomes lower, more toner is replenished. As the flow characteristics become poor, less toner is replenished.

Therefore, even when the counters are the same, the actual amount of replenishment varies depending on the flow characteristics and the level, resulting in an error in the remaining amount of the toner cartridge 30.

Therefore, in the embodiment, the occurrence of an error is prevented using the correction coefficients illustrated in FIGS. 12 and 13. The correction factor illustrated in FIG. 12 is an integration update correction factor. The correction factor illustrated in FIG. 13 is the replenishment counter correction factor.

In FIGS. 12 and 13, when the flow characteristics are “good”, the total amount is less than 4 g. When the flow characteristics are “medium”, the total amount is 4 g or more and less than 8 g. When the flow characteristics are “poor”, the total amount is 8 g or more.

The integration update correction factor illustrated in FIG. 12 will be described. After the toner replenishment by the toner replenishment motor 31, the control unit 400 acquires a counter for a current replenishment. The control unit 400 sets a product of the acquired counter and the integration update correction factor as a counter after correction, and adds the counter after correction to the integration counter of the toner characteristic information B.

Therefore, the correction factor illustrated in FIG. 12 becomes larger as the level becomes lower and becomes smaller as the flow characteristics become worse. At Level 1, the correction coefficient when the flow characteristics are “good” is 1.00. At Level 1, the correction factor when the flow characteristics are “medium” is 1.00. At Level 1, the correction factor when the flow characteristics are “poor” is 0.99.

At Level 2, the correction coefficient when the flow characteristics are “good” is 1.00. At Level 2, the correction factor when the flow characteristics are “medium” is 0.98. At Level 2, the correction factor when the flow characteristics are “poor” is 0.95.

At Level 3, the correction factor when the flow characteristics are “good” is 1.00. At Level 3, the correction factor when the flow characteristics are “medium” is 0.96. At Level 3, the correction factor when the flow characteristics are “poor” is 0.92.

As described above, when a small amount of toner is actually replenished, the occurrence of an error can be prevented by correcting the counter to be small.

The replenishment counter correction factor illustrated in FIG. 13 will be described. When the toner replenishment motor 31 replenishes toner, the control unit 400 obtains an amount of replenishment from the amount of toner detected by the toner remaining amount detection sensor 37.

The control unit 400 acquires a counter of the toner replenishment motor 31 required to replenish toner in the amount of replenishment. The amount of replenishment and the value of the counter corresponding to the amount of replenishment are stored in advance in the ROM 320 based on Level 1 when the flow characteristics are “good”.

The control unit 400 operates the toner replenishment motor 31 for a counter after correction using a product of the acquired counter and the replenishment counter correction factor as the counter after correction.

Therefore, the correction coefficient illustrated in FIG. 13 becomes smaller as the level becomes lower and becomes larger as the flow characteristics become worse. At Level 1, the correction coefficient when the flow characteristics are “good” is 1.00. At Level 1, the correction factor when the flow characteristics are “medium” is 1.00. At Level 1, the correction factor when the flow characteristics are “poor” is 1.01.

At Level 2, the correction coefficient when the flow characteristics are “good” is 1.00. At Level 2, the correction factor when the flow characteristics are “medium” is 1.02. At Level 2, the correction factor when flow characteristics are “poor” is 1.05.

At Level 3, the correction factor when the flow characteristics are “good” is 1.00. At Level 3, the correction factor when the flow characteristics are “medium” is 1.04. At Level 3, the correction factor when flow characteristics are “poor” is 1.09.

As described above, when a small amount of toner is actually replenished, the occurrence of an error can be prevented by correcting the counter to be large.

The flow characteristics illustrated in FIGS. 12 and 13 are determined for each toner stored in the toner cartridge 30, and do not change. Therefore, any one flow characteristic correction coefficient is set for the correction coefficients 1 to 3 of the toner characteristic information. For example, for the integration update correction factor, the correction factor 1 when the flow characteristics of toner are “poor” is 0.99. The correction factor 2 when the flow characteristics are “poor” is 0.95. The correction factor 3 when the flow characteristics are “poor” is 0.92.

Next, an embodiment using a particle diameter to illustrate the characteristics of toner will be described. When an average particle diameter is small and the amount of fine powder is large, the toner may be easily thickened in the toner cartridge 30. Therefore, since the toner is more likely to be replenished the toner is more likely to be replenished in an agglomerated state, the amount of replenishment is considered to be large.

In the embodiment using a particle diameter, the amount of fine powder is classified with respect to the particle diameter. The following method can be used as a method of calculating the amount of fine powder. A Coulter counter multisizer 3 (manufactured by Beckman Coulter, Inc.) may be used as a measuring device used to calculate the amount of fine powder. A measurer measures an aperture diameter of 100 μm and a count number of 50000 in the measuring device. The measurer calculates the amount of fine powder (P3/D50) with respect to a particle diameter using a 50% volume average particle diameter D50 [μm] and number based relative particle amount P3 [%] of 3 μm or less. The amount of fine powder is classified by the value.

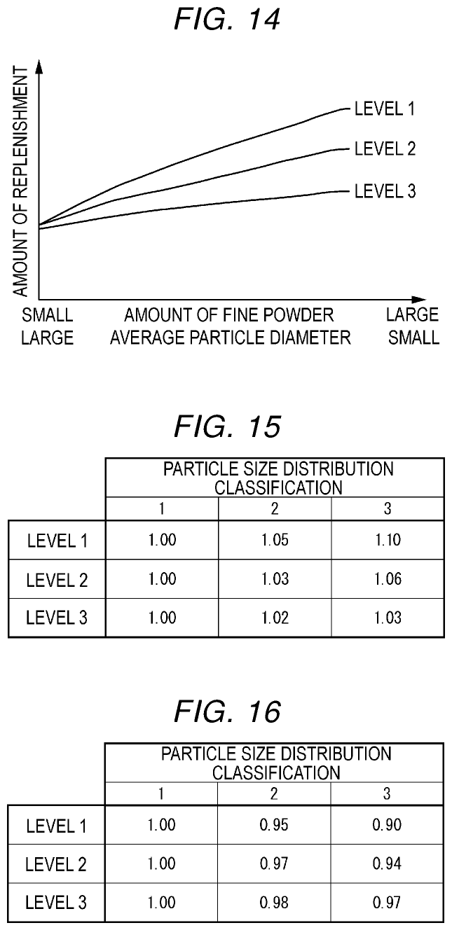

FIG. 14 is a diagram illustrating the relationship between the amount of fine powder and the amount of replenishment, and the average particle diameter and the amount of replenishment. The vertical axis indicates the amount of replenishment, and the horizontal axis indicates the amount of fine powder, and the average particle diameter. The amount of replenishment indicates the amount of replenishment when the toner replenishment motor 31 rotates once. Levels 1 to 3 are levels described in FIG. 7.

As described above, as the level becomes lower, more toner is replenished. As the amount of fine powder becomes larger, more toner is replenished. As the average particle diameter becomes smaller, more toner is replenished.

Therefore, even when the counters are the same, the actual amount of replenishment varies depending on the amount of fine powder, the average particle diameter and the level, and an error occurs in the remaining amount of the toner cartridge 30.

Therefore, in the embodiment, the occurrence of an error is prevented using the correction coefficients illustrated in FIGS. 15 and 16. The correction factor illustrated in FIG. 15 is an integration update correction factor. The correction factor illustrated in FIG. 16 is a replenishment counter correction factor.

In FIGS. 15 and 16, when the particle size distribution classification is “1”, the amount of fine powder with respect to the particle diameter is less than 0.5. When the particle size distribution classification is “2”, the amount of fine powder with respect to the particle diameter is 0.5 or more and less than 1.6. When the particle size distribution classification is “3”, the amount of fine powder with respect to the particle diameter is 1.6 or more.

The integration update correction factor illustrated in FIG. 15 will be described. After the toner replenishment by the toner replenishment motor 31, the control unit 400 acquires a counter for a current replenishment. The control unit 400 sets a product of the acquired counter and the integration update correction factor as a counter after correction, and adds the counter after correction to the integration counter of the toner characteristic information B.

Therefore, the correction coefficient illustrated in FIG. 15 becomes larger as the level becomes lower, and becomes larger as the particle size distribution classification becomes larger. At Level 1, the correction coefficient when the particle size distribution classification is “1” is 1.00. At Level 1, the correction coefficient when the particle size distribution classification is “2” is 1.05. At Level 1, the correction factor when the particle size distribution classification is “3” is 1.10.

At Level 2, the correction coefficient when the particle size distribution classification is “1” is 1.00. At Level 2, the correction coefficient when the particle size distribution classification is “2” is 1.03. At Level 2, the correction coefficient when the particle size distribution classification is “3” is 1.06.

At Level 3, the correction coefficient when the particle size distribution classification is “1” is 1.00. At Level 3, the correction coefficient when the particle size distribution classification is “2” is 1.02. At Level 3, the correction coefficient when the particle size distribution classification is “3” is 1.03.

As described above, when a large amount of toner is actually replenished, the occurrence of an error can be prevented by correcting the counter to be large.

The replenishment counter correction factor illustrated in FIG. 16 will be described. When the toner replenishment motor 31 replenishes toner, the control unit 400 obtains an amount of replenishment from the amount of toner detected by the toner remaining amount detection sensor 37.

The control unit 400 acquires a counter of the toner replenishment motor 31 required to replenish toner in the amount of replenishment. The amount of replenishment and the value of the counter corresponding to the amount of replenishment are stored in advance in the ROM 320 based on Level 1 when the particle size distribution classification difference is “1”.

The control unit 400 operates the toner replenishment motor 31 for a counter after correction using a product of the acquired counter and the replenishment counter correction factor as the counter after correction.

Therefore, the correction coefficient illustrated in FIG. 16 becomes smaller as the level becomes lower and becomes smaller as the particle size distribution classification becomes larger. At Level 1, the correction coefficient when the particle size distribution classification is “1” is 1.00. At Level 1, the correction factor when the particle size distribution classification is “2” is 0.95. At Level 1, the correction coefficient when the particle size distribution classification is “3” is 0.90.

At Level 2, the correction coefficient when the particle size distribution classification is “1” is 1.00. At Level 2, the correction factor when the particle size distribution classification is “2” is 0.97. At Level 2, the correction coefficient when the particle size distribution classification is “3” is 0.94.

At Level 3, the correction coefficient when the particle size distribution classification is “1” is 1.00. At Level 3, the correction factor when the particle size distribution classification is “2” is 0.98. The correction coefficient when the particle size distribution classification is “3” is 0.97.

As described above, when a large amount of toner is actually supplied, the occurrence of an error can be prevented by correcting the counter to be small.

The particle size distribution classification illustrated in FIGS. 15 and 16 is determined for each toner stored in the toner cartridge 30, and does not change. Therefore, any one particle size distribution classification correction coefficient is set for correction coefficients 1 to 3 of the toner characteristic information. For example, for the integration update correction factor, the correction factor 1 when the particle size distribution of toner is “3” is 1.10. The correction factor 2 when the toner particle size distribution classification is “3” is 1.06. The correction coefficient 3 when the toner particle size distribution classification is “3” is 1.03.

Next, a flow of the remaining amount information derivation process will be described. The correction factor includes an integration update correction factor and a replenishment counter correction factor, and the remaining amount information derivation process is different for each factor. First, the flow of the remaining amount information derivation process when using an integration update correction factor will be described.

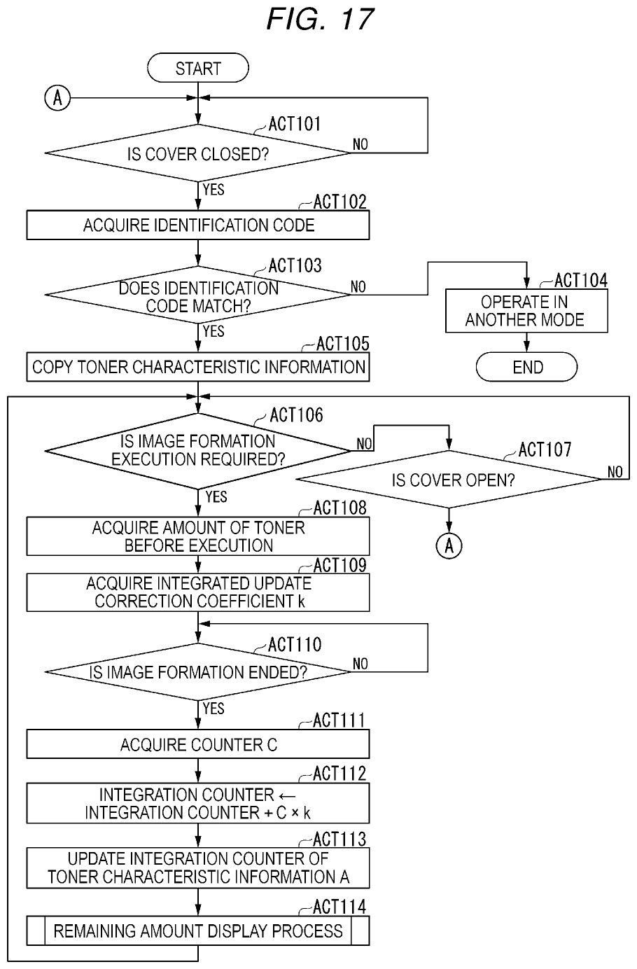

FIG. 17 is a flowchart illustrating a flow of the remaining amount information derivation process performed by the control unit 400 when an integration update correction factor is used. The control unit 400 determines whether a cover for storing the toner cartridge 30 is closed (ACT 101). When the cover is closed (ACT101: YES), an identification code of toner characteristic information A is acquired (ACT 102).

The control unit 400 determines whether the acquired identification code matches with the identification code of toner characteristic information B (ACT 103). When the acquired identification code does not match with the identification code of the toner characteristic information B (ACT 103: NO), the control unit 400 is operated in another mode which does not execute a process related to the remaining amount of toner (ACT 104) and ends the process. The case in which the identification code does not match means that a toner cartridge set is a counterfeit product or the like.

When the acquired identification code matches with the identification code of the toner characteristic information B (ACT 103: YES), the control unit 400 copies the toner characteristic information A to the toner characteristic information B (ACT 105).

The control unit 400 determines whether an image formation execution request is made according to an instruction from a user or the like (ACT 106). When the image formation execution request is not made (ACT 106: NO), the control unit 400 determines whether the cover is opened (ACT 107). When the cover is open (ACT 107: YES), a process returns to ACT 101. When the cover is not open (ACT 107: NO), the process returns to ACT 106.

When the image formation execution request is made (ACT 106: YES), the control unit 400 acquires a toner amount indicating the amount of toner stored in the developing device 14 before performing image formation (ACT 108). The toner amount is detected by the toner remaining amount detection sensor 37. The control unit 400 determines the level from the toner amount and the toner characteristic information B, and acquires an integration update correction factor k corresponding to the level (ACT 109).

When the image formation is completed (ACT 110: YES), the control unit 400 acquires a counter C for a current replenishment (ACT 111). The control unit 400 updates the integration counter of the toner characteristic information B as a new integration counter by adding a product of C and the integration update correction factor k to the integration counter of the toner characteristic information B (ACT 112). As described above, the control unit 400 derives remaining amount information on the remaining amount of toner in the toner cartridge 30 based on the acquired counter, the correction coefficient of toner characteristic information, and the amount of stored toner. The integration counter is information obtained by integrating the product of the counter and the correction coefficient.

The control unit 400 updates the integration counter of the toner characteristic information A by overwriting the integration counter of the toner characteristic information B on the integration counter of the toner characteristic information A (ACT 113).

The control unit 400 executes the remaining amount display process for displaying the remaining amount of toner on the display 110 (ACT 114), and returns the process to ACT 106.

As illustrated in FIG. 17, by using the integration update correction factor, the integration counter corresponding to the actual amount of replenishment can be obtained, and thus the occurrence of an error can be prevented.

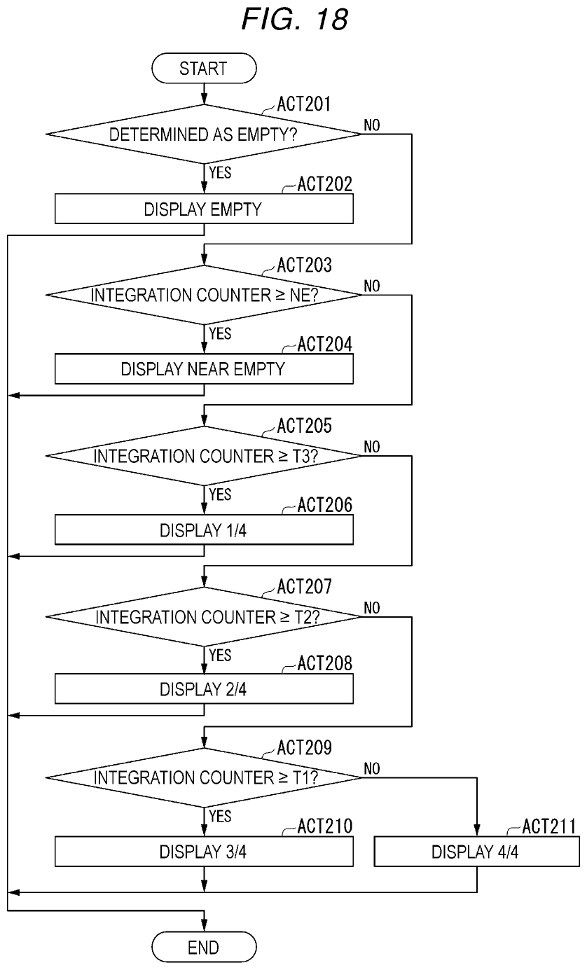

Next, the flow of the remaining amount display process will be described. FIG. 18 is a flowchart illustrating the flow of the remaining amount display process performed by the control unit 400. The control unit 400 determines whether the toner cartridge 30 is empty (ACT 201). The control unit 400 determines that the toner cartridge 30 is empty when the toner remaining amount detection sensor 37 cannot confirm an increase in the amount of toner even after toner replenishment.

When it is determined that the toner cartridge 30 is empty (ACT 201: YES), the control unit 400 performs empty display on the display 110 (ACT 202), and ends the process.

When it is determined that the toner cartridge 30 is not empty (ACT 201: NO), the control unit 400 determines whether the integration counter is equal to or greater than the threshold value NE (ACT 203). When the integration counter is equal to or greater than the threshold value NE (ACT 203: YES), the control unit 400 performs near-empty display on the display 110 (ACT 204), and ends the process.

When the integration counter is not equal to or greater than the threshold NE (ACT 203: NO), the control unit 400 determines whether the integration counter is equal to or greater than the threshold T3 (ACT 205). When the integration counter is equal to or greater than the threshold T3 (ACT 205: YES), the control unit 400 causes the display 110 to display 1/4 indicating that the remaining amount is about 1/4 (ACT 206), and ends the process.

When the integration counter is not equal to or greater than the threshold T3 or more (ACT 205: NO), the control unit 400 determines whether the integration counter is equal to or greater than the threshold T2 (ACT 207). When an integration counter is equal to or larger than the threshold T2 (ACT 207: YES), the control unit 400 causes the display 110 to display 2/4 indicating that the remaining amount is about 2/4 (ACT 208), and ends the process.

When the integration counter is not equal to or greater than the threshold T2 (ACT 207: NO), the control unit 400 determines whether the integration counter is equal to or greater than the threshold T1 (ACT 209). When the integration counter is equal to or greater than the threshold T1 (ACT 209: YES), the control unit 400 causes the display 110 to display 3/4 indicating that the remaining amount is about 3/4 (ACT 210), and ends the process.

When the integration counter is not equal to or greater than the threshold T1 (ACT 209: NO), the control unit 400 causes the display 110 to display 4/4 indicating that the remaining amount is about 4/4 (ACT 211), and ends the process.

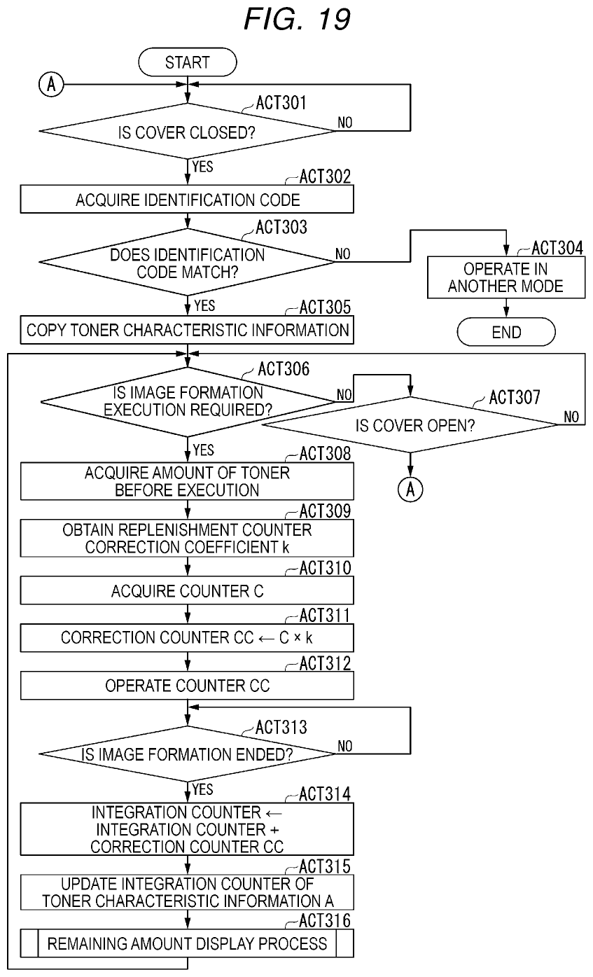

FIG. 19 is a flowchart illustrating the flow of the remaining amount information derivation process performed by the control unit 400 when a replenishment counter correction factor is used. The control unit 400 determines whether the cover for storing the toner cartridge 30 is closed (ACT 301). When the cover is closed (ACT 301: YES), an identification code of toner characteristic information A is acquired (ACT 302).

The control unit 400 determines whether the acquired identification code matches with the identification code of the toner characteristic information B (ACT 303). When the acquired identification code does not match with the identification code of the toner characteristic information B (ACT 303: NO), the control unit 400 is operated in another mode that does not execute a process related to the remaining amount of toner (ACT 304), and ends the process. The case in which the identification code does not match means that the set toner cartridge is a counterfeit product or the like.

When the acquired identification code matches with the identification code of the toner characteristic information B (ACT 303: YES), the control unit 400 copies the toner characteristic information A to the toner characteristic information B (ACT 305).

The control unit 400 determines whether an image formation execution request is made according to a user instruction or the like (ACT 306). When the image formation execution request is not made (ACT 306: NO), the control unit 400 determines whether the cover is opened (ACT 307). When the cover is open (ACT 307: YES), the process returns to ACT 301. When the cover is not open (ACT 307: NO), the process returns to ACT 306.

When the image formation execution request is made (ACT 306: YES), the control unit 400 acquires a toner amount indicating the amount of toner stored in the developing device 14 before performing image formation (ACT 308). The control unit 400 determines the level from the toner amount and the toner characteristic information B, and acquires a replenishment counter correction coefficient k corresponding to the level (ACT 309).

The control unit 400 acquires the counter C of the toner replenishment motor 31 required for replenishing toner in the amount of replenishment from the stored toner amount (ACT 310). The control unit 400 sets a product of the counter C and the replenishment counter correction coefficient k as a correction counter CC (ACT 311).

The control unit 400 causes the toner supply motor 31 to operate for the correction counter CC (ACT 312). When the image formation is completed (ACT 313: YES), the control unit 400 updates the integration counter of the toner characteristic information B as a new integration counter (ACT 314) by adding the correction counter CC to the integration counter of the toner characteristic information B. The control section 400 updates the integration counter of the toner characteristic information A by overwriting the integration counter of the toner characteristic information B on the integration counter of the toner characteristic information A (ACT 315).

The control unit 400 executes the remaining amount display process for displaying the remaining amount of toner on the display 110 (ACT 316), and the process returns to ACT 306.

As illustrated in FIG. 19, by using the replenishment counter correction coefficient, an integration counter corresponding to the actual amount of replenishment can be obtained, and thus the occurrence of an error can be prevented.

As described above, even when any one of the integration update correction coefficient and the replenishment counter correction coefficient is used, the integration counter corresponding to the actual amount of replenishment can be obtained, and thus the occurrence of an error can be prevented.

The correction coefficient in the embodiment described above is merely an example. Depending on the shape of the toner cartridge and the replenishment method, a small amount of toner may be replenished although a large amount of toner is replenished in the embodiment.

That is, the correction coefficient is appropriately determined according to the shape of the toner cartridge and the replenishment method.

Although there are three levels for determining the correction coefficient, the number of levels may be two or four or more. Although three types of correction coefficients are provided for each level, two types or four or more types may be used.

In the present embodiment, first, the correction coefficient is determined according to the characteristics of the toner. In the embodiment, the correction coefficient is determined according to the time after the toner is stirred by replenishment or the like. Thereby, the remaining amount suitable for the actual amount of replenishment can be more reliably derived, and thus the occurrence of an error can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming apparatus, comprising:
a replenishing component that replenishes a recording agent from a recording agent cartridge to a collecting component;
an operation acquisition component that acquires a physical quantity that is proportional to operation of the replenishing component;
a characteristic acquisition component that acquires characteristic information determined by characteristics of the recording agent, wherein the characteristic information comprises a replenishing flow characteristic of the recording agent;
a recording agent amount acquisition component that acquires a recording agent amount indicating an amount of the recording agent stored in the collecting component; and
a derivation component that derives remaining amount information of a remaining amount of the recording agent in the recording agent cartridge based on:
the physical quantity acquired by the operation acquisition component,
the characteristic information acquired by the characteristic acquisition component, and
the recording agent amount acquired by the recording agent amount acquisition component.

2. The apparatus according to claim 1, wherein the characteristic information is stored in a storage component provided in the recording agent cartridge, and wherein the characteristic acquisition component acquires the characteristic information from the storage component.

3. The apparatus according to claim 1, wherein the replenishing component replenishes the recording agent by operating a motor, and wherein the physical quantity comprises a quantity determined by operation time of the motor.

4. The apparatus according to claim 1, wherein the replenishing component replenishes the recording agent by operating a motor, and wherein the physical quantity comprises a quantity determined by physical repetitions of the motor.

5. The apparatus according to claim 1, wherein the characteristic information comprises a coefficient to be calculated with the physical quantity, and wherein the derivation component derives the remaining amount information based on a calculation result of the physical quantity and the coefficient.

6. The apparatus according to claim 5, wherein the remaining amount information is obtained by integrating a product of the physical quantity and the coefficient.

7. The apparatus according to claim 1, wherein the characteristic information comprises a threshold value to be compared with the remaining amount information.

8. A recording agent cartridge in which a recording agent is accommodated, the cartridge comprising:
a storage component that stores characteristic information for deriving remaining amount information of a remaining amount of the recording agent in the recording agent cartridge, wherein the characteristic information comprises a replenishing flow characteristic of the recording agent.

9. The cartridge according to claim 8, wherein the characteristic information further comprises characteristics of the recording agent.

10. The cartridge according to claim 8, wherein the characteristic information further comprises a coefficient for calculating a physical quantity in proportion to the replenishing flow characteristic and operation of a replenishing component that replenishes the recording agent in an image forming apparatus to which the recording agent cartridge is attached.

11. The cartridge according to claim 8, wherein the characteristic information further comprises a threshold value to be compared with the remaining amount information.

12. The cartridge according to claim 10, wherein the physical quantity comprises a quantity determined by operation time of a motor operating the replenishing component.

13. The cartridge according to claim 10, wherein the physical quantity comprises a quantity determined by physical repetitions of a motor operating the replenishing component.

14. A method for an image forming apparatus, comprising:
replenishing a recording agent from a recording agent cartridge to a collecting component;
acquiring a physical quantity that is proportional to operation of the replenishing component;
acquiring characteristic information determined by characteristics of the recording agent, wherein the characteristic information comprises a replenishing flow characteristic of the recording agent;
acquiring a recording agent amount indicating an amount of the recording agent stored in the collecting component; and
deriving remaining amount information of a remaining amount of the recording agent in the recording agent cartridge based on the physical quantity acquired, the characteristic information acquired, and the recording agent amount acquired.

15. The method according to claim 14, further comprising:
acquiring the characteristic information from a storage component provided in the recording agent cartridge.

16. The method according to claim 14, further comprising:
replenishing the recording agent by operating a motor, and
determining the physical quantity by operation time of the motor.

17. The method according to claim 14, further comprising:
replenishing the recording agent by operating a motor, and
determining the physical quantity by physical repetitions of the motor.

18. The method according to claim 14, further comprising:
deriving the remaining amount information based on a calculation result of the physical quantity and a coefficient to be calculated with the physical quantity.

19. The method according to claim 18, further comprising:
obtaining the remaining amount information by integrating a product of the physical quantity and the coefficient.

20. The method according to claim 14, wherein the characteristic information further comprises a threshold value to be compared with the remaining amount information.

21. The image forming apparatus of claim 1, wherein the replenishing flow characteristic comprises a speed with which the collecting component is replenished with the recording agent from the recording agent cartridge.

22. The image forming apparatus of claim 1, wherein the characteristic acquisition component acquires the replenishing flow characteristic based on an identified density of the recording agent stored in the recording agent cartridge.

23. The image forming apparatus of claim 22, wherein the identified density of the recording agent stored in the recording agent cartridge comprises a bulk density difference of the recording agent stored in the recording agent cartridge, and wherein the bulk density difference of the recording agent comprises a difference between a bulk density of the recording agent and a loose density of the recording agent.

24. The image forming apparatus of claim 23, wherein the bulk density difference is determined by the characteristic acquisition component by a process comprising:
removing a sample of the recording agent from the recording agent cartridge,
agitating the sample,
measuring a loose density of the sample,
packing the sample,
measuring a packed bulk density of the sample, and
determining the difference between the bulk density of the recording agent and the loose density of the recording agent.
